(19) United States
(12) Patent Application Publication
(10) Pub. No.: US 2026/0371118 A1
(43) Pub. Date: Nov. 19, 2026

(54) UE BEHAVIOR TO ALLOW INTERRUPTION WHEN REPORTING NEED FOR GAP

(71) Applicant: Intel Corporation, Santa Clara, CA (US)

(72) Inventors: Rui Huang, Beijing (CN); Andrey Chervyakov, Maynooth (IE); In-Seok Hwang, Santa Clara, CA (US); Hua Li, Beijing 11 (CN); Meng Zhang, Beijing (CN)

(21) Appl. No.: 19/152,993

(22) PCT Filed: Feb. 7, 2024
(86) PCT No.: PCT/US2024/014760

§ 371 Date: Aug. 1, 2025

Related U.S. Application Data
(60) Provisional application No. 63/487,808, filed on Mar. 1, 2023.

(51) Int. Cl. H04W 24/08; H04W 56/00

(52) U.S. Cl. CPC H04W 24/08; H04W 56/001

(57) ABSTRACT

A user equipment (UE) configured for operating in a fifth-generation new radio (5G NR) network may cause an interruption on an indicated frequency layer to perform the synchronization signal block (SSB)-based measurements without gaps. The UE may encode a radio-resource control (RRC) information element for transmission to a gNodeB (gNB) to indicate that interruption is needed for performing synchronization signal block (SSB) based measurements without gaps. During the performance of the SSB-based measurements without gaps, the UE may interrupt scheduled downlink receptions and/or uplink transmissions. The UE may be configured to limit the interruption to less than a maximum interruption ratio (D) and a maximum interruption length (L) for an interruption occasion

### PRIORITY CLAIM

This application claims the benefit of priority to U.S. Provisional Patent Application Ser. No. 63/487,808, filed Mar. 1, 2023 [reference number AF2233-Z] which is incorporated herein by reference in its entirety.

### TECHNICAL FIELD

Embodiments pertain to wireless communications.

### BACKGROUND

One issue with communicating data over a wireless network is . . . Mobile communications have evolved significantly from early voice systems to today's highly sophisticated integrated communication platform. With the increase in different types of devices communicating with various network devices, usage of 3GPP 5G NR systems has increased. The penetration of mobile devices (user equipment or UEs) in modern society has continued to drive demand for a wide variety of networked devices in many disparate environments. 5G NR wireless systems are forthcoming and are expected to enable even greater speed, connectivity, and usability, and are expected to increase throughput, coverage, and robustness and reduce latency and operational and capital expenditures. 5G-NR networks will continue to evolve based on 3GPP LTE-Advanced with additional potential new radio access technologies (RATs) to enrich people's lives with seamless wireless connectivity solutions delivering fast, rich content and services. As current cellular network frequency is saturated, higher frequencies, such as millimeter wave (mmWave) frequency, can be beneficial due to their high bandwidth.

One issue with current 5G networks is that UEs may need to perform radio resource management (RRM) measurements with measurement gaps. Measurement gaps can reduce user throughput and introduce latency since the UE has to temporarily stop receiving/transmitting data over the serving cell during the gap period. This could be especially problematic for URLLC use cases. Another issue is that more frequent measurement gaps may be needed in 5G compared to 4G due to the wider bandwidth and use of higher frequency bands. This further reduces available transmission time for the UE. Beamforming at mmWave frequencies makes taking measurements more challenging. The UE may need to sweep its beam direction during the gap period to detect different base station beams, reducing measurement accuracy. With ultra dense 5G networks, the number of cells the UE needs to scan during the gap can increase substantially. The UE may not be able to scan all frequencies and cells of interest within the gap duration. With dynamic TDD and flexible UE/base station coordination of downlink and uplink transmissions in 5G, managing gaps appropriately so as not to conflict with scheduled UL/DL transmissions becomes more complex.

### BRIEF DESCRIPTION OF THE DRAWINGS

FIG. 1A illustrates an architecture of a network, in accordance with some embodiments.

FIG. 1B and FIG. 1C illustrate a non-roaming 5G system architecture in accordance with some embodiments.

FIG. 2 illustrates a functional block diagram of a wireless communication device, in accordance with some embodiments.

FIG. 3 illustrates the use of one or more measurement gap patterns in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some embodiments disclosed herein are directed to a user equipment (UE) configured for operating in a fifth-generation new radio (5G NR) network. In these embodiments, the UE may be configured to cause an interruption on an indicated frequency layer to perform the synchronization signal block (SSB)-based measurements without gaps.

In some embodiments, the UE may encode a radio-resource control (RRC) information element for transmission to a gNodeB (gNB) to indicate that interruption is needed for performing synchronization signal block (SSB) based measurements without gaps. In these embodiments, processing circuitry of the UE may configure the UE to cause an interruption on an indicated frequency layer to perform the SSB-based measurements without gaps. In these embodiments during the performance of the SSB-based measurements without gaps, the UE may interrupt scheduled downlink receptions and/or uplink transmissions. IN these embodiments, the UE may be configured to limit the interruption to less than a maximum interruption ratio (D) and a maximum interruption length (L) for an interruption occasion. These embodiments, as well as others, are described in more detail below.

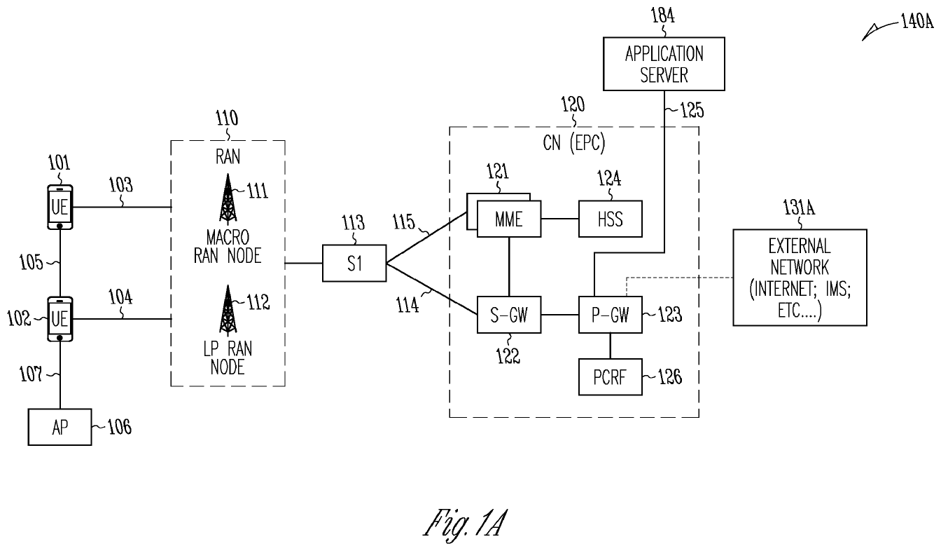

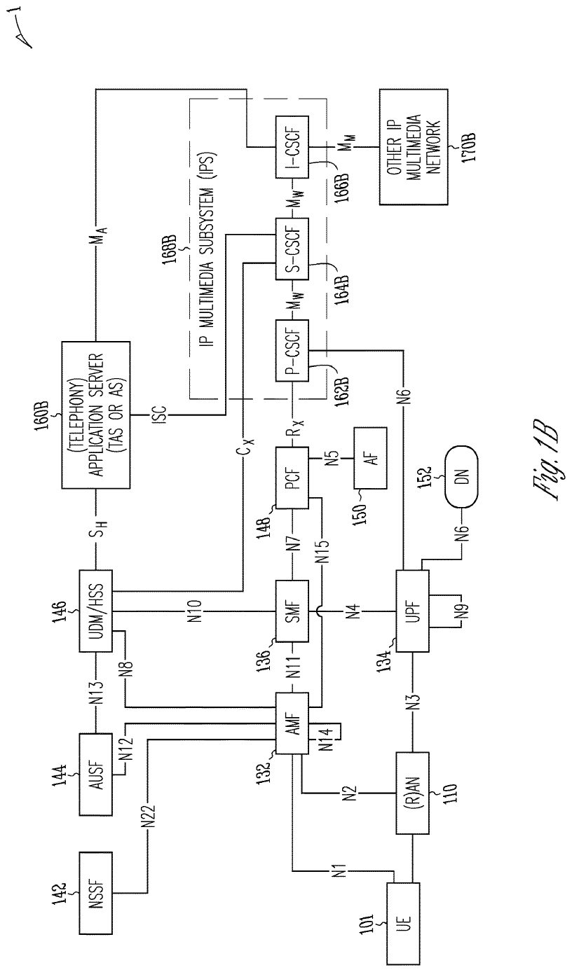

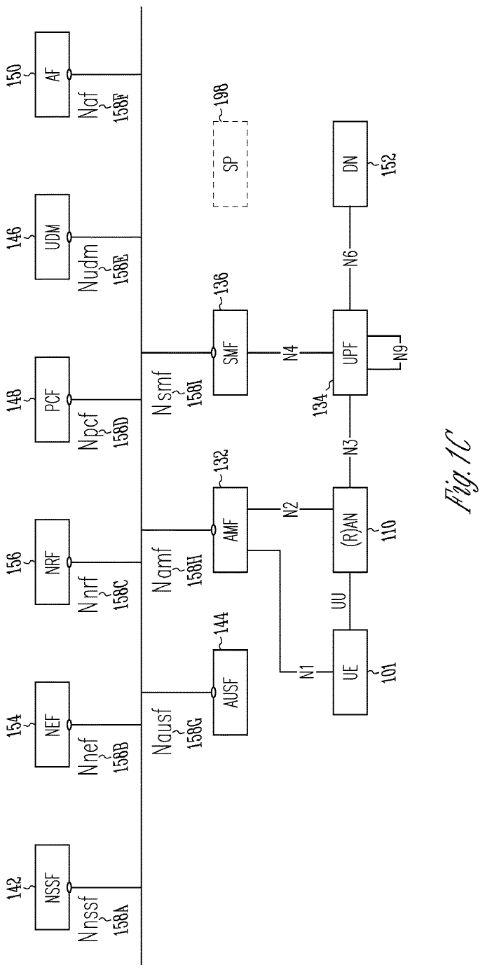

FIG. 1A illustrates an architecture of a network in accordance with some embodiments. The network 140A is shown to include user equipment (UE) 101 and UE 102. The UE 101 and UE 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. The UE 101 and UE 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard.

LTE and LTE-Advanced are standards for wireless communications of high-speed data for UE such as mobile telephones. In LTE-Advanced and various wireless systems, carrier aggregation is a technology according to which multiple carrier signals operating on different frequencies may be used to carry communications for a single UE, thus increasing the bandwidth available to a single device. In some embodiments, carrier aggregation may be used where one or more component carriers operate on unlicensed frequencies.

Embodiments described herein can be used in the context of any spectrum management scheme including, for example, dedicated licensed spectrum, unlicensed spectrum, (licensed) shared spectrum (such as Licensed Shared Access (LSA) in 2.3-2.4 GHZ, 3.4-3.6 GHZ, 3.6-3.8 GHz, and further frequencies and Spectrum Access System (SAS) in 3.55-3.7 GHZ and further frequencies).

Embodiments described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

In some embodiments, any of the UE 101 and UE 102 can comprise an Internet-of-Things (IoT) UE or a Cellular IoT (CIoT) UE, which can comprise a network access layer designed for low-power IoT applications utilizing short-lived UE connections. In some embodiments, any of the UE 101 and UE 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

In some embodiments, any of the UE 101 and UE 102 can include enhanced MTC (eMTC) UEs or further enhanced MTC (FeMTC) UEs.

The UE 101 and UE 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The UE 101 and UE 102 utilize connections 103 and 104, respectively, each of which comprises a physical communications interface or layer (discussed in further detail below); in this example, the connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UE 101 and UE 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some embodiments, the RAN nodes 111 and 112 can be transmission/reception points (TRPs). In instances when the RAN nodes 111 and 112 are NodeBs (e.g., eNBs or gNBs), one or more TRPs can function within the communication cell of the NodeBs. The RAN 110 may include one or more RAN nodes for providing macrocells, e.g., macro-RAN node, and one or more RAN nodes for providing femtocells or picocells (e.g., cells having smaller coverage areas, smaller user capacity, or higher bandwidth compared to macrocells), e.g., low power (LP) RAN node.

Any of the RAN nodes 111 and 112 can terminate the air interface protocol and can be the first point of contact for the UE 101 and UE 102. In some embodiments, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the RAN nodes 111 and/or 112 can be a new generation Node-B (gNB), an evolved node-B (eNB), or another type of RAN node.

The RAN 110 is shown to be communicatively coupled to a core network (CN) 120 via an S1 interface 113. In embodiments, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility embodiments in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UE 101 and UE 102 via the CN 120.

The P-GW 123 may further be a node for policy enforcement and charging data collection. Policy and Charging Rules Function (PCRF) 126 is the policy and charging control element of the CN 120. In a non-roaming scenario, in some embodiments, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some embodiments, the communication network 140A can be an IoT network or a 5G network, including 5G new radio network using communications in the licensed (5G NR) and the unlicensed (5G NR-U) spectrum. One of the current enablers of IoT is the narrowband-IoT (NB-IoT).

An NG system architecture can include the RAN 110 and a 5G network core (5GC). In these embodiments, the RAN 110 can include a plurality of nodes, such as gNBs and NG-eNBs. The CN 120 (e.g., a 5G core network or 5GC) can include an access and mobility function (AMF) and/or a user plane function (UPF). The AMF and the UPF can be communicatively coupled to the gNBs and the NG-eNBs via NG interfaces. More specifically, in some embodiments, the gNBs and the NG-eNBs can be connected to the AMF by NG-C interfaces, and to the UPF by NG-U interfaces. The gNBs and the NG-eNBs can be coupled to each other via Xn interfaces.

In some embodiments, the NG system architecture can use reference points between various nodes as provided by 3GPP Technical Specification (TS) 23.501 (e.g., V15.4.0, 2018-12). In some embodiments, each of the gNBs and the NG-eNBs can be implemented as a base station, a mobile edge server, a small cell, a home eNB, and so forth. In some embodiments, a gNB can be a master node (MN) and NG-eNB can be a secondary node (SN) in a 5G architecture.

FIG. 1B illustrates a non-roaming 5G system architecture in accordance with some embodiments. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF 132 can be used to manage access control and mobility and can also include network slice selection functionality. The SMF 136 can be configured to set up and manage various sessions according to network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

In some embodiments, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain embodiments of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some embodiments, the I-CSCF 166B can be connected to another IP multimedia network 170E, e.g. an IMS operated by a different network operator.

In some embodiments, the UDM/HSS 146 can be coupled to an application server 160E, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM/HSS 146 and the AMF 132, not shown), N9 (between two UPFs 134, not shown), N10 (between the UDM/HSS 146 and the SMF 136, not shown), N11 (between the AMF 132 and the SMF 136, not shown), N12 (between the AUSF 144 and the AMF 132, not shown), N13 (between the AUSF 144 and the UDM/HSS 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some embodiments, 5G system architectures can be service-based and interaction between network functions can be represented by corresponding point-to-point reference points Ni or as service-based interfaces.

In some embodiments, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM/HSS 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

In some embodiments, any of the UEs or base stations described in connection with FIGS. 1A-1C can be configured to perform the functionalities described herein.

Mobile communication has evolved significantly from early voice systems to today's highly sophisticated integrated communication platform. The next generation wireless communication system, 5G, or new radio (NR) will provide access to information and sharing of data anywhere, anytime by various users and applications. NR is expected to be a unified network/system that targets to meet vastly different and sometimes conflicting performance dimensions and services. Such diverse multi-dimensional requirements are driven by different services and applications. In general, NR will evolve based on 3GPP LTE-Advanced with additional potential new Radio Access Technologies (RATs) to enrich people's lives with better, simple, and seamless wireless connectivity solutions. NR will enable everything connected by wireless and deliver fast, rich content and services.

Rel-15 NR systems are designed to operate on the licensed spectrum. The NR-unlicensed (NR-U), a short-hand notation of the NR-based access to unlicensed spectrum, is a technology that enables the operation of NR systems on the unlicensed spectrum.

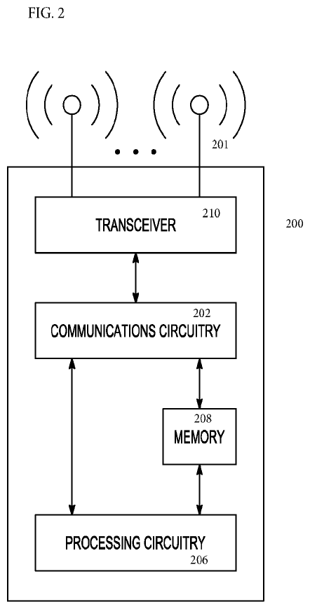

FIG. 2 illustrates a functional block diagram of a wireless communication device, in accordance with some embodiments. Wireless communication device 200 may be suitable for use as a UE or gNB configured for operation in a 5G NR or 6G network. Some embodiments are directed to an apparatus of a UE or gNB comprising processing circuitry and memory configured for operation in a 5G NR or 6G network.

The wireless communication device 200 may include communications circuitry 202 and a transceiver 210 for transmitting and receiving signals to and from other communication devices using one or more antennas 201. The communications circuitry 202 may include circuitry that can operate the physical layer (PHY) communications and/or medium access control (MAC) communications for controlling access to the wireless medium, and/or any other communications layers for transmitting and receiving signals. The wireless communication device 200 may also include processing circuitry 206 and memory 208 arranged to perform the operations described herein. In some embodiments, the communications circuitry 202 and the processing circuitry 206 may be configured to perform operations detailed in the above figures, diagrams, and flows.

In accordance with some embodiments, the communications circuitry 202 may be arranged to contend for a wireless medium and configure frames or packets for communicating over the wireless medium. The communications circuitry 202 may be arranged to transmit and receive signals. The communications circuitry 202 may also include circuitry for modulation/demodulation, upconversion/downconversion, filtering, amplification, etc. In some embodiments, the processing circuitry 206 of the wireless communication device 200 may include one or more processors. In other embodiments, two or more antennas 201 may be coupled to the communications circuitry 202 arranged for sending and receiving signals. The memory 208 may store information for configuring the processing circuitry 206 to perform operations for configuring and transmitting message frames and performing the various operations described herein. The memory 208 may include any type of memory, including non-transitory memory, for storing information in a form readable by a machine (e.g., a computer). For example, the memory 208 may include a computer-readable storage device, read-only memory (ROM), random-access memory (RAM), magnetic disk storage media, optical storage media, flash-memory devices and other storage devices and media.

In some embodiments, the wireless communication device 200 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the wireless communication device 200 may include one or more antennas 201. The antennas 201 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting device.

In some embodiments, the wireless communication device 200 may include one or more of a keyboard, a display, a non-volatile memory port, multiple antennas, a graphics processor, an application processor, speakers, and other mobile device elements. The display may be an LCD screen including a touch screen.

Although the wireless communication device 200 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the wireless communication device 200 may refer to one or more processes operating on one or more processing elements.

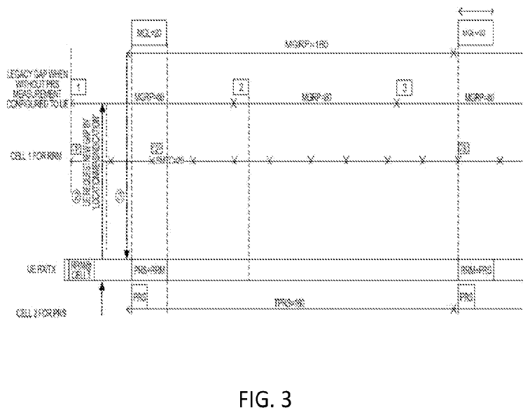

FIG. 3 illustrates the use of one or more measurement gap patterns in accordance with some embodiments. In these embodiments, a user equipment (UE) configured for operation in a 5th generation (5G) network may be configured with an initial measurement gap (MG) configuration for measurement of radio-resource management (RRM) signals. In these embodiments, the UE may request a new MG configuration from a generation node B (gNB) for measurement of positioning reference signal (PRS) in response to a location procedure initiated by a location measurement function (LMF) in the network (see FIG. 3). In these embodiments, the UE may decode a measurement gap configuration (MeasGapConfig) information element (IE) from the gNB (see FIG. 3). The MeasGapConfig IE may configure (i.e., grant) the UE with the new MG configuration. In these embodiments, the UE may be configured for performing at least PRS measurements in accordance with the new MG configuration (see FIG. 3).

In some embodiments, the UE may be configured to cause an interruption on an indicated frequency layer to perform the synchronization signal block (SSB)-based measurements without use of the gaps that illustrated in FIG. 3. In these embodiments, the SSB-based measurements that are performed without gaps may be conducted outside of any configured measurement gaps (FIG. 3). These embodiments are discussed in more detail below. A new WID on further enhancements on NR measurement gap [1] has been approved in 3GPP RP #89e, as follows:

The following objectives are considered in this WI:
Enhancements of pre-configured MGs, multiple concurrent MGs and NCSG
Define RRM requirements for UEs configured with a combination of pre-configured MGs, and/or multiple concurrent MGs and/or NCSG [RAN4]

Prioritize at least joint requirements for UE configured with
Case 1: Pre-configured MGs and multiple concurrent MGs (i.e., concurrent MGs where at least one of the gaps is a pre-configured gap)
Case 2: NCSG and multiple concurrent MGs (i.e., concurrent MGs where at least one of the gaps is NCSG).

Note: Prioritization among other possible combinations of pre-configured MG, concurrent MG and NCSG can be discussed in WI phase

Define RRM requirements for measurement without gaps for the following cases:
NR SSB-based inter-frequency and intra-frequency measurements without gaps for UEs reporting NeedForGapsInfoNR IE [RAN4]
Study whether the additional interruption is allowed when UE reporting ‘NeedForGapsInfoNR’. Further define the interruption length, occasion and ratio, if the interruption is allowed
Define related requirements, such as CSSF, measurement period, scheduling restriction etc.

Embodiments herein may relate to objective 2 in the work item [1]. For example, embodiments herein may define UE capability on UE measurements with the pre-configured gaps. Embodiments may be used in a wireless cellular network, such as a NR network.

In the last RAN4 meeting, several options of the open issue on whether the interruption requirements when UE reporting NeedforGapInfoNR was captured:
Introduce additional Rel-18 UE signalling to differentiate UE supporting no gap with interruption (Case 2)
Signalling details are FFS.

From RAN4 perspective, more clarity and detail regarding UE behaviors when the interruption allowed is needed. For example, embodiments may relate to one or more of:

interruption length
interruption location
interruption ratio

In some embodiments, the interruption requirements may be based on:
interruption length and location; and/or
interruption length ratio
When using the interruption ratio as the requirements, in case of the shorter measurement cycle (e.g. 80 ms) in order to reduce the total interruption duration UE has to reduce the RF retuning time to the extent possible. Accordingly, the UE may need to keep power-on outside of SMTC. This will increase total power consumption.

In order to avoid such problem, embodiments herein may provide that:
The interruption ratio can be defined depending on the measurement cycles. And the interruption duration per a cycle can be less than a pre-defined value [e.g., 1 ms]. For an example, if the measurement cycle (P) is larger than m1, the ratio can be less than k1%;
Else if m1<P<P2, ratio<k2%

### Example Implementation in 3GPP TS 38.133

In TS38.133 the following interruption requirements shall be applied to UE when UE performing the measurement reporting “nogap” but interruption allowed. Interruptions during measurements on UE reporting NeedForGap with interruption allowed. Interruptions on PCell or activated SCell(s) due to measurements when UE reporting to support “NeedForGap with nogap-interruption” are allowed
with up to [k1%] probability of missed ACK/NACK over a cycle (e.g. measCycle1) is m1 ms or longer”
with up to [k2%] probability of missed ACK/NACK over a cycle (e.g. measCycle1) is m2 ms or longer”
k1>k2, m1<m2

In some embodiments, the UE may encode a radio-resource control (RRC) information element for transmission to a gNodeB (gNB) to indicate that interruption is needed for performing synchronization signal block (SSB) based measurements without gaps. In these embodiments, processing circuitry of the UE may configure the UE to cause an interruption on an indicated frequency layer to perform the SSB-based measurements without gaps. In these embodiments during the performance of the SSB-based measurements without gaps, the UE may interrupt scheduled downlink receptions and/or uplink transmissions. IN these embodiments, the UE may be configured to limit the interruption to less than a maximum interruption ratio (D) and a maximum interruption length (L) for an interruption occasion. These embodiments, as well as others, are described in more detail below.

In some embodiments, the RRC IE may comprise a NeedForInterruptionInfoNR information element (IE) when the UE supports performing the SSB-based measurements without gaps with interruptions.

In some embodiments, the UE may to encode the NeedForInterruptionInfoNR IE to include a per-band capability for performing SSB-based measurements without gaps with interruptions. In some embodiments, the NeedForInterruptionInfoNR IE may include the indicated frequency layer, although the scope of the embodiments is not limited in this respect.

In some embodiments, the UE may decode an RRC reconfiguration message from the gNB. In these embodiments, the RRC reconfiguration message may comprise a needForInterruptionConfigNR IE. In these embodiments, when the RRC reconfiguration message indicates that the needForInterruptionConfigNR IE indicates enabled, the RRC reconfiguration message further includes a second NeedForInterruptionInfoNR IE that indicates that information previously provided by the UE in the NeedForInterruptionInfoNR IE is changed.

In some embodiments, the maximum interruption ratio (D) on the frequency layer (i) that the UE is allowed to cause may be equal to twice the maximum interruption length (L) divided by an interruption cycle (Tcycle). In some embodiments, the maximum interruption ratio (D) is based on the interruption cycle (Tcycle) on the indicated frequency layer to limit missed ACK/NACKs at the gNB.

In some embodiments, during the interruption occasion, when the UE interrupts reception of a physical downlink shared channel (PDSCH) scheduled by a physical downlink control channel (PDCCH), the UE fails to receive the interrupted PDSCH and does not send an ACK/NACK for the interrupted PDSCH.

In some embodiments, the maximum interruption ratio (D) on each of active serving cells due to UE measurements without gap applied is:

$$D = {\sum }_{i = 1}^{N} \frac{2 L}{{T}_{cycle , i}}$$

where N is a total number of configured SSB based frequency layers to be measured outside gap including intra-frequency and inter-frequency target carriers where UE indicates that interruption is needed through no-gap-with-interruption, and L is the maximum interruption length in slots for each interruption occasion.

In some embodiments, the interruption length (L) is based on a subcarrier spacing (SCS) configuration and the frequency range. In some embodiments, the maximum interruption ratio (D) and the maximum interruption length (L) for an interruption occasion are stored in the memory of the UE.

In some embodiments, the SSB-based measurements that are performed without gaps comprise one of intra-frequency SSB-based measurements and inter-frequency SSB-based measurements. In these embodiments, the SSB-based measurements that are performed without gaps may be conducted outside of any configured measurement gaps.

In some embodiments, when the UE does not indicate that interruption is needed for performing SSB-based measurements without gaps, the UE may decode a measurement gap configuration IE received from the gNB that configures the UE with measurement gaps for performing the SSB-based measurements and the UE may perform the SSB-based measurements during the configured measurement gaps.

Some embodiments are directed to non-transitory computer-readable storage medium that stores instructions for execution by processing circuitry of a user equipment (UE) configured for operating in a fifth-generation new radio (5G NR) network. In these embodiments, the processing circuitry may encode a radio-resource control (RRC) information element for transmission to a gNodeB (gNB) to indicate that interruption is needed for performing synchronization signal block (SSB) based measurements without gaps. The processing circuitry may configure the UE to cause an interruption on an indicated frequency layer to perform the SSB-based measurements without gaps. In these embodiments, during the performance of the SSB-based measurements without gaps, the UE interrupts any scheduled downlink receptions and/or uplink transmissions. In these embodiments, the interruption may be limited to less than a maximum interruption ratio (D) and a maximum interruption length (L) for an interruption occasion.

Some embodiments are directed to a gNodeB (gNB) configured for operating in a fifth-generation new radio (5G NR) network. In these embodiments, the gNB may decode a radio-resource control (RRC) information element received from a user equipment (UE), the RRC information element indicating that interruption is needed by the UE for performing synchronization signal block (SSB) based measurements without gaps. In these embodiments, the gNB may also encode an RRC reconfiguration message for transmission to the UE comprising a needForInterruptionConfigNR IE. In these embodiments, when the RRC reconfiguration message indicates that the needForInterruptionConfigNR IE indicates enabled, the RRC reconfiguration message may further includes a second NeedForInterruptionInfoNR IE that indicates that information previously provided by the UE in the NeedForInterruptionInfoNR IE is changed.

### EXAMPLES

Example 1 may include a method to define UE behavior when UE performing the measurement without gap but to allow interruption.

Example 2 may include the method of example 1 or some other example herein, wherein interruption length shall be specified.

Example 3 may include the method of example 1 or some other example herein, wherein the total interruption ratio over a configured cycle shall be followed by UE.

Example 4 may include method of example 3 or some other example herein, wherein the total interruption ratio can be dependent with the range of cycle.

Example 5 may include the method of example 4 or some other example herein, wherein the interruption ratio for smaller cycles can be less than that for larger cycles.

Example 6 may include a method of a user equipment (UE), the method comprising:
identifying a requirement for an interruption in a cell for a measurement; and
performing the measurement with the interruption based on the requirement.

Example 7 may include the method of example 6 or some other example herein, wherein the requirement includes a length of the interruption.

Example 8 may include the method of example 6-7 or some other example herein, wherein the requirement includes a location of the interruption (e.g., in time and/or frequency resources).

Example 9 may include the method of example 6-8 or some other example herein, wherein requirement includes a maximum ratio of a duration of the interruption compared with a length of a measurement cycle.

Example 10 may include the method of example 9 or some other example herein, wherein a value of the ratio is based on the length of the measurement cycle.

Example 11 may include the method of example 10 or some other example herein, wherein the ratio is a first predefined value when the length of the measurement cycle is greater than a threshold and is a second predefined value when the length of the measurement cycle is less than the threshold.

Example 12 may include the method of example 6-11 or some other example herein, wherein the requirement corresponds to a probability of a missed ACK/NACK over a measurement cycle.

Example 13 may include the method of example 6-12 or some other example herein, further comprising reporting an indication of a need for measurement gap with interruption allowed, wherein the requirement is based on the indication.

Example 14 may include the method of example 6-13 or some other example herein, wherein the cell is a primary cell or an activated secondary cell.

Example 15 may include the method of example 6-14 or some other example herein, wherein the measurement includes an inter-frequency measurement or an intra-frequency measurement.

The Abstract is provided to comply with 37 C.F.R. Section 1.72 (b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus for a user equipment (UE) configured for operating in a fifth-generation new radio (5G NR) network, the apparatus comprising: processing circuitry; and memory, wherein the processing circuitry is configured to:
encode a radio-resource control (RRC) information element for transmission to a gNodeB (gNB) to indicate that interruption is needed for performing synchronization signal block (SSB) based measurements without gaps; and
configure the UE to cause an interruption on an indicated frequency layer to perform the SSB-based measurements without gaps;
wherein during the performance of the SSB-based measurements without gaps, the UE interrupts any scheduled downlink receptions and/or uplink transmissions, and
wherein the processing circuitry is configured to limit the interruption to less than a maximum interruption ratio (D) and limit the interruption to a maximum interruption length (L) for an interruption occasion.

2. The apparatus of claim 1, wherein the RRC IE comprises a NeedForInterruptionInfoNR information element (IE) when the UE supports performing the SSB-based measurements without gaps with interruptions.

3. The apparatus of claim 2, wherein the processing circuitry is configured to encode the NeedForInterruptionInfoNR IE to include a per-band capability for performing SSB-based measurements without gaps with interruptions, the NeedForInterruptionInfoNR IE to include the indicated frequency layer.

4. The apparatus of claim 3, wherein the processing circuitry is configured to decode an RRC reconfiguration message from the gNB, the RRC reconfiguration message comprising a needForInterruptionConfigNR IE, wherein when the RRC reconfiguration message indicates that the needForInterruptionConfigNR IE indicates enabled, the RRC reconfiguration message further includes a second NeedForInterruptionInfoNR IE that indicates that information previously provided by the UE in the NeedForInterruptionInfoNR IE is changed.

5. The apparatus of claim 3 wherein the maximum interruption ratio (D) on the frequency layer (i) that the UE is allowed to cause is equal to twice the maximum interruption length (L) divided by an interruption cycle (Tcycle).

6. The apparatus of claim 5, wherein the maximum interruption ratio (D) is based on the interruption cycle (Tcycle) on the indicated frequency layer to limit missed ACK/NACKs at the gNB.

7. The apparatus of claim 5, wherein during the interruption occasion, when the UE interrupts reception of a physical downlink shared channel (PDSCH) scheduled by a physical downlink control channel (PDCCH), the UE fails to receive the interrupted PDSCH and does not send an ACK/NACK for the interrupted PDSCH.

8. The apparatus of claim 5, wherein the maximum interruption ratio (D) on each of active serving cells due to UE measurements without gap applied is:
$$D = {\sum }_{i = 1}^{N} \frac{2 L}{{T}_{cycle , i}}$$
where N is a total number of configured SSB based frequency layers to be measured outside gap including intra-frequency and inter-frequency target carriers where UE indicates that interruption is needed through no-gap-with-interruption, and L is the maximum interruption length in slots for each interruption occasion.

9. The apparatus of claim 8, wherein the interruption length (L) is based on a subcarrier spacing (SCS) configuration and a frequency range.

10. The apparatus of claim 8, wherein the maximum interruption ratio (D) and the maximum interruption length (L) for an interruption occasion are stored in the memory of the UE.

11. The apparatus of claim 5, wherein the SSB-based measurements that are performed without gaps comprise one of intra-frequency SSB-based measurements and inter-frequency SSB-based measurements, and
wherein the SSB-based measurements that are performed without gaps are conducted outside of any configured measurement gaps.

12. The apparatus of claim 5, wherein when the UE does not indicate that interruption is needed for performing SSB-based measurements without gaps, the processing circuitry is configured to:
decode a measurement gap configuration IE received from the gNB that configures the UE with measurement gaps for performing the SSB-based measurements; and
perform the SSB-based measurements during the configured measurement gaps.

13. A computer-readable storage medium that stores instructions for execution by processing circuitry of a user equipment (UE) configured for operating in a fifth-generation new radio (5G NR) network, the processing circuitry is configured to:
encode a radio-resource control (RRC) information element for transmission to a gNodeB (gNB) to indicate that interruption is needed for performing synchronization signal block (SSB) based measurements without gaps; and
configure the UE to cause an interruption on an indicated frequency layer to perform the SSB-based measurements without gaps;
wherein during the performance of the SSB-based measurements without gaps, the UE interrupts any scheduled downlink receptions and/or uplink transmissions, and
wherein the processing circuitry is configured to limit the interruption to less than a maximum interruption ratio (D) and limit the interruption to a maximum interruption length (L) for an interruption occasion.

14. The computer-readable storage medium of claim 13, wherein the RRC IE comprises a NeedForInterruptionInfoNR information element (IE) when the UE supports performing the SSB-based measurements without gaps with interruptions.

15. The computer-readable storage medium of claim 14, wherein the processing circuitry is configured to encode the NeedForInterruptionInfoNR IE to include a per-band capability for performing SSB-based measurements without gaps with interruptions, the NeedForInterruptionInfoNR IE to include the indicated frequency layer.

16. The computer-readable storage medium of claim 15, wherein the processing circuitry is configured to decode an RRC reconfiguration message from the gNB, the RRC reconfiguration message comprising a needForInterruptionConfigNR IE, wherein when the RRC reconfiguration message indicates that the needForInterruptionConfigNR IE indicates enabled, the RRC reconfiguration message further includes a second NeedForInterruptionInfoNR IE that indicates that information previously provided by the UE in the NeedForInterruptionInfoNR IE is changed.

17. The computer-readable storage medium of claim 15 wherein the maximum interruption ratio (D) on the frequency layer (i) that the UE is allowed to cause is equal to twice the maximum interruption length (L) divided by an interruption cycle (Tcycle).

18. The computer-readable storage medium of claim 17, wherein the maximum interruption ratio (D) is based on the interruption cycle (Tcycle) on the indicated frequency layer to limit missed ACK/NACKs at the gNB.

19. An apparatus for gNodeB (gNB) configured for operating in a fifth-generation new radio (5G NR) network, the apparatus comprising: processing circuitry; and memory, wherein the processing circuitry is configured to:
decode a radio-resource control (RRC) information element received from a user equipment (UE), the RRC information element indicating that interruption is needed by the UE for performing synchronization signal block (SSB) based measurements without gaps; and
refrain from configuring the UE with measurement gaps to perform the SSB-based measurements in response to the RRC information element,
wherein the UE is configured to cause an interruption on an indicated frequency layer to perform the SSB-based measurements without gaps;
wherein during the performance of the SSB-based measurements without gaps, the UE interrupts a scheduled downlink reception and/or uplink transmission, and
wherein the interruption is limited to less than a maximum interruption ratio (D) and limited to a maximum interruption length (L) for an interruption occasion.

20. The apparatus of claim 19, wherein the processing circuitry is further configured to encode an RRC reconfiguration message for transmission to the UE, the RRC reconfiguration message comprising a needForInterruptionConfigNR IE,
wherein when the RRC reconfiguration message indicates that the needForInterruptionConfigNR IE indicates enabled, the RRC reconfiguration message further includes a second NeedForInterruptionInfoNR IE that indicates that information previously provided by the UE in the NeedForInterruptionInfoNR IE is changed.
